(19) United States
(12) Patent Application Publication
(10) Pub. No.: US 2019/0199097 A1
(43) Pub. Date: Jun. 27, 2019

(54) System for controlling electrical power generation

(71) Applicant: Vladimir Antonovich DENDYUK, Noviy Urengoy (RU)

(72) Inventor: Vladimir Antonovich DENDYUK, Noviy Urengoy (RU)

(21) Appl. No.: 13/512,421

(22) PCT Filed: Sep. 27, 2011
(86) PCT No.: PCT/RU11/00737

§ 371 Date: Mar. 7, 2013

(30) Foreign Application Priority Data
Oct. 22, 2010 (RU) 2010143233

(51) Int. Cl. H02J 3/38; H02J 13/00; H02H 7/06; H02H 1/00; G05B 15/02

(52) U.S. Cl. CPC H02J 3/381; H02J 13/0075; G05B 15/02; H02H 1/0061; H02H 1/0092; H02H 7/06

(57) ABSTRACT

The proposed system for controlling electrical power generation includes power generating units each having an electrical generator parallel-connected to an electric grid via a circuit breaker, programmable control and protection means, and a primary power engine. At least one active loading device is connected to the grid parallel to the generator. The programmable control and protection means include a microprocessor-based excitation system, an automatic excitation regulation controller, and an electrical generator differential protection controller. The controllers are connected to one another and to the microprocessor-based excitation system, the circuit breaker and a plant computer for controlling the power generating units, the plant computer being the end point in a two-way wireless communication link with a dispatch computer for remotely controlling and monitoring the power generating units.

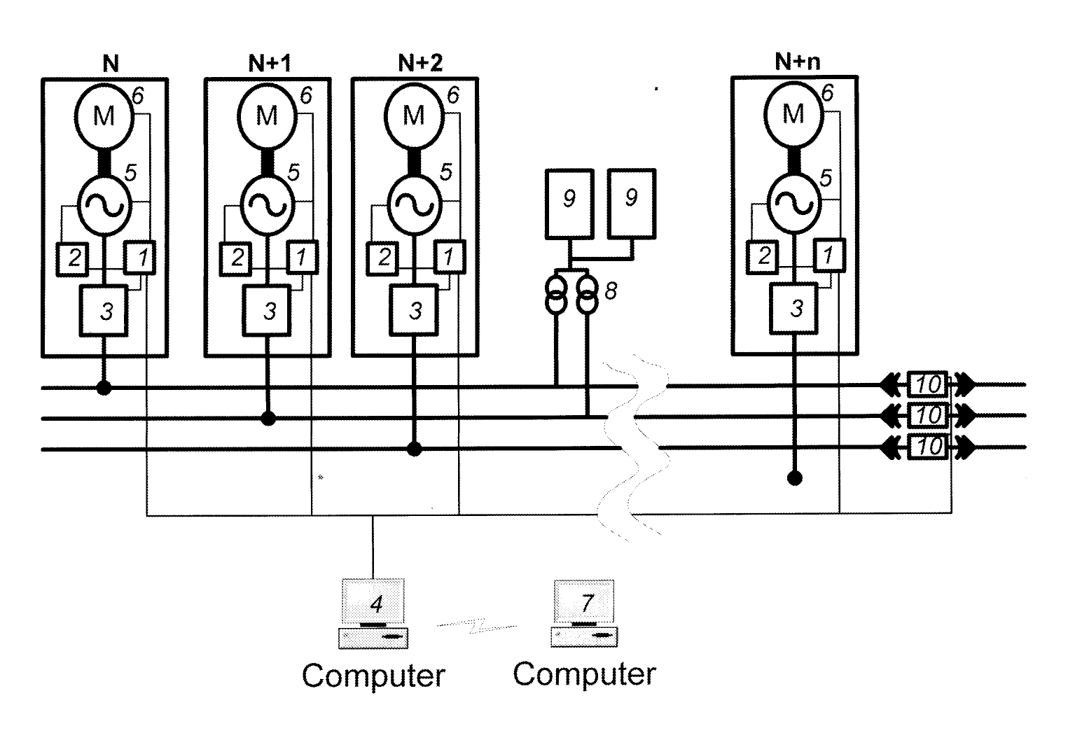

### CROSS-REFERENCES TO RELATED APPLICATIONS

This application is a U.S. national stage application of a PCT application PCT/RU2011/000737 filed on 27 Sep. 2011, published as WO/2012/053934, whose disclosure is incorporated herein in its entirety by reference, which PCT application claims priority of a Russian Federation application RU2010143233 filed on 22 Oct. 2010, now a Russian Federation Patent RU2435270 issued on 27 Nov. 2011.

### FIELD OF INVENTION

The proposed invention relates to the field of generation of electrical power and can be utilized for control of generation of electrical energy, preferably, in extreme climate conditions.

### BACKGROUND OF THE INVENTION

As a related art system nearest to the proposed invention, the instant inventors consider a system for control of electrical energy generation taught in U.S. Pat. No. 5,973,481 issued 26 Oct. 1999 to National Bank of Alaska, Alaska Science and Technology Foundation. The system described in U.S. Pat. No. 5,973,481 includes a system of power generating units parallel-connected to an electric grid, wherein each such power generating unit includes a primary power engine (diesel), an electrical generator, circuit breakers, and programmable means of control and circuit protection.

The programmable control means of each power generating unit include a controller with a user interface, connected with a final point of a two-way wireless satellite communication channel, which final point is furnished with a dispatch computer for remote control and managing the power generating units.

Managing the operation of the power generating units is essentially provided via a controller of the corresponding power generating unit, while the controller is controlled by certain software being updated as necessary that provides required operation modes for the power generating unit. The system proposed in U.S. Pat. No. 5,973,481 allows for remote control of power plants situated in distal and hardly accessible locations without mandatory presence of respective personnel in such power plants.

A major drawback of similar known systems is an insufficient reliability in conditions of emergency switching off the power generating equipment (blackouts), and in conditions of abrupt and unexpected weather changes, as well as impossibility of manual control in such conditions.

### BRIEF DESCRIPTION OF THE INVENTION

The proposed invention allows avoiding the shortcomings of known power generation control systems, and creating a power generation control system with an improved reliability in emergency situations, as well as in other situations not envisaged by common rules for servicing the power generation equipment.

The present invention allows for solving the aforementioned problem by providing a system for control of electrical power generation, which system, in its preferred embodiment, comprises: at least two power generating units located on a power plant, each such power generating unit is parallel-connected to an electric grid and includes a primary power engine, an electric generator, circuit breakers, programmable means of control and circuit protection, connected with a remote end point of a two-way wireless communication channel associated with a dispatch computer for remote control and managing the power generating units; wherein, according to the present invention, an active load device is connected to the electric grid parallel to the power generating units; the programmable means of control and circuit protection include: —a microprocessor excitation circuitry including a converter, preferably assembled based on bi-polar transistors with an isolated gate, wherein the microprocessor excitation circuitry is immediately connected to an exciter of the electric generator, —a controller for automatic regulation of excitation of the electric generator, and—a controller of differential circuit protection of the electric generator, wherein the controller for automatic regulation and the controller of differential circuit protection are interconnected with each other, and with a plant end computer of the two-way wireless communication channel being a plant point (located on the power plant) communicated with the dispatch computer (located outside the power plant) for remotely managing the power generating units.

In preferred embodiments of the inventive system, the controller of differential circuit protection is connected with at least one high voltage circuit breaker of a corresponding electric transmission line. The controller for automatic regulation is connected with the microprocessor excitation circuitry, the exciter of electric generator, and a vacuum circuit breaker of the electric generation unit.

In preferred embodiments of the inventive system, the controller of differential circuit protection and the controller for automatic regulation are connected with the each other, with the microprocessor excitation circuitry, the circuit breakers, and the plant computer via wired communication channels, though in some embodiments wireless communication channels can be utilized therefor.

The microprocessor excitation circuitry is preferably supplied with a user interface capable of adjusting the control elements thereof. Since the inventive system will be heavily deployed in arctic regions and in regions of expressed continental climate, the programmable means of control and circuit protection can be thermostated, e.g. might be placed in thermo-insulated cases.

In preferred embodiments, the aforesaid communication channel can be represented by a satellite channel. Employment of other types of wireless communication channels is also possible, e.g. regular RF channels. The primary power engine can be represented by a gas-turbine engine or a diesel engine; mobile power installations (mobile automatic electric stations) can also be utilized.

### BRIEF DESCRIPTION OF DRAWING

FIGURE attached hereto schematically shows the system for control of electrical power generation, according to a preferred embodiment of the present invention.

### DETAIL DESCRIPTION OF PREFERRED EMBODIMENTS

The proposed system for control of electrical power generation is illustrated on FIGURE. The base portion of the system is a plurality of power generating units N, N+1, N+2, . . . , N+n, which provide for generation of electric energy, and which are parallel connected to an electric grid. FIGURE depicts the embodiment that employs power generating units utilizing the aforesaid mobile automatic electric stations.

Active load devices 9 are associated with the electric grid via transformers 8 connected in parallel to the power generating units N, N+1, N+2, . . . , N+n. Each of the power generating units includes known equipment: a primary power installation 6 (a gas-turbine or diesel engine, or an engine of another conventional type), an electric generator 5, circuit breakers 3 and 10, thermostated programmable means of control and circuit protection 1 and 2.

The programmable means of control and circuit protection 1, 2 include controllers 1 and an excitation circuitry 2, which are connected with a plant computer 4 being an end point of a two-way wireless channel for communication with a dispatch computer 7 for remote control and management of the power generation units. The communication channel is preferably represented by a satellite communication channel.

The proposed control system can be employed as a part of a scaled power supply system arranged on any area and territory relief. The microprocessor excitation circuitry 2 incorporates a converter preferably assembled based on bi-polar transistors with an isolated gate (e.g. a known excitation circuitry with an IGBT converter). The controllers 1 encompass an automatic regulation controller (AGC) 1^{AGC} and a controller of differential circuitry protection (MDR) 1^{MDR}.

The excitation circuitry 2 is associated with a user interface for manual adjusting the excitation circuitry, which excitation circuitry is immediately connected to an exciter of the electric generator 5; the controller of automatic regulation and the controller of differential protection of electric generator are interconnected, and connected with the microprocessor excitation circuitry 2, and circuit breakers 3 and 10.

The controller of differential protection 1^{MDR} is connected with high voltage circuit breakers 10 of electric transmission lines. The controller of automatic regulation 1^{AGC} is connected with the microprocessor excitation circuitry 2, the exciter of the electric generator, and the vacuum circuit breaker 3 of the power generating unit. For connection of the controller of differential protection 1^{MDR} and the controller of automatic regulation 1^{AGC} wired (established connection technology) or wireless (where wires can be damaged) communication channels can be employed.

Collective operation of the controller of automatic regulation 1^{AGC} and the controller of differential protection 1^{MDR} provides for uninterrupted management of operation of the whole power supply system under conditions of abrupt seasonal and daytime temperature changes and various phase lags (overloads and under-loads, short circuits, etc.).

The controller of automatic regulation 1^{AGC} automatically distributes the electrical load among the power generating units N, N+1, N+2, . . . , N+n proportionally, or according to pre-set up threshold values, and provides for all protection types of the primary power engine 6 and electrical generator 5. The controller of differential protection 1^{MDR} provides for circuit protection within the section starting from the vacuum circuit breaker 3 to the generator 5.

The excitation circuitry 2 provides for connecting the power generating unit to the electric grid by a precise synchronization method, automatic adjustment of voltage of the electric generator 5 to the grid voltage, an accelerated reestablishing the voltage of generator 5 upon jumps of the electrical load, maintaining the voltage in pre-set up limits under surgeless raising and reducing the rotation speed of the electric generator 5.

In case of failure of consumer load devices and disconnection of the high voltage circuit breakers 10, the active load devices 9 provide for electric load of the power generating units N, N+1, N+2, . . . , N+n without an actuation of reverse power protection and a fragmentation of parallel connection.

Control of the controller of automatic regulation 1^{AGC}, the controller of differential protection 1^{MDR}, and the excitation circuitry 2, as well as control for current state of the power supply system, and recording events can be accomplished through a satellite communication channel (or an on-earth radio-communication channel) from the dispatch computer 7, providing remote control. Alternatively, if necessary, manual control of the power generating units can be accomplished from the plant computer 4.

Adjustments of the microprocessor excitation circuitry 2 can be carried out from the computers 4 and 7, as well as immediately via the aforementioned user interface.

Thusly, the proposed system for control of electrical power generation provides for high reliability, and can be applied for non-interruptive production of electric energy, especially in locations with extremely continental and arctic climate.

1. A system for controlling electrical power generation comprising:
at least two power generating units located on a power plant; each said power generating unit is parallel connected substantially to an electric grid, each said power generating unit including: an electric generator furnished with an exciter, and programmable means of control and circuit protection;
a two-way communication channel having a first end point located on the power plant and a second end point located outside of the power plant; said two-way communication channel essentially connects a plant computer with a dispatch computer; said plant computer is installed at the first end point, and used for controlling said at least two power generating units; said dispatch computer is installed at the second end point and used for remote controlling said at least two power generating units via said two-way communication channel;
at least one active electric load device parallel connected to said at least two power generating units; and
a number of circuit breakers switchably connecting said at least two power generating units and said at least one active electric load device with said electric grid through electric transmission lines;
wherein said programmable means of control and circuit protection include:
a microprocessor excitation circuitry connected to said exciter of the corresponding electric generator,
a controller of automatic regulation of excitation of the corresponding electric generator, and
a controller of differential protection of the corresponding electric generator; and
said controller of automatic regulation and said controller of differential protection are connected to each other, and connected at least with the corresponding microprocessor excitation circuitry, said circuit breakers, and said plant computer.

2. The system according to claim 1, wherein the controller of differential protection is connected with at least one said circuit breaker of the corresponding electric transmission line.

3. The system according to claim 1, wherein the controller of automatic regulation is connected with said microprocessor excitation circuitry.

4. The system according to claim 1, wherein the controller of automatic regulation is connected with said exciter.

5. The system according to claim 1, wherein the controller of automatic regulation is connected with said vacuum circuit breaker.

6. The system according to claim 1, wherein the controller of automatic regulation and the controller of differential protection are connected with each other, with said microprocessor excitation circuitry, said circuit breakers, and said plant computer via wired communication channels.

7. The system according to claim 1, wherein the controller of automatic regulation and the controller of differential protection are connected with each other, with said microprocessor excitation circuitry, said circuit breakers, and said plant computer via wireless communication channels.

8. The system according to claim 1, wherein said microprocessor excitation circuitry is furnished with a user interface capable of adjusting said microprocessor excitation circuitry.

9. The system according to claim 1, wherein said programmable means of control and circuit protection are thermostated.

10. The system according to claim 1, wherein said two-way communication channel is represented by a satellite channel.

11. The system according to claim 1, wherein said two-way communication channel is represented by a wireless communication channel, another than a satellite channel.

12. The system according to claim 1, wherein each said power generating unit includes a primary power engine represented by at least one gas-turbine engine.

13. The system according to claim 12, wherein said primary power engine is made mobile.

14. The system according to claim 1, wherein each said power generating unit includes a primary power engine represented by at least one diesel engine.

15. The system according to claim 14, wherein said primary power engine is made mobile.
